(19) United States
(12) Patent Application Publication
(10) Pub. No.: US 2013/0339085 A1
(43) Pub. Date: Dec. 19, 2013

(54) IDENTIFYING A NON-OBVIOUS TARGET AUDIENCE FOR AN ADVERTISING CAMPAIGN

(71) Applicant: KENSHOO LTD., Tel-Aviv (IL)

(72) Inventors: EYAL SADEH, HERZELIYA (IL); GILAD ARMON, AMIRIM (IL); TAL HASSON, PETACH TIKVA (IL)

(21) Appl. No.: 13/913,551

(22) Filed: Jun. 10, 2013

Related U.S. Application Data
(60) Provisional application No. 61/658,979, filed on Jun. 13, 2012.

(51) Int. Cl. G06Q 30/02

(52) U.S. Cl. CPC G06Q 30/0255
USPC 705/7.29

(57) ABSTRACT

Identifying candidate topics for the allocation of advertising resources by calculating a relevance value of a candidate topic with respect to a base topic as a function of a number of individuals that is associated with the base topic, a number of individuals that is associated with the candidate topic, and a number of individuals that is associated with both the base topic and the candidate topic, determining that the relevance value of the candidate topic is above a predefined threshold, and identifying the candidate topic as a target for an advertising resource.

### CROSS-REFERENCE TO RELATED APPLICATIONS

This application claims the benefit of U.S. Provisional Patent Application No. 61/658,979, filed Jun. 13, 2012, which is incorporated herein by reference in its entirety.

### FIELD OF THE INVENTION

The present inventions relates to advertising in general, and more particularly to identifying target audiences for advertising campaigns.

### BACKGROUND OF THE INVENTION

A typical goal of market research is to determine a relevant audience for an advertising campaign in order to optimize the allocation of advertising resources. One common technique in online marketing is to associate one or more keywords with products or services that are offered by an advertiser. These associations are then used by the advertiser to provide advertisements for the products or services to users who perform search engine queries, but only if the search queries use one or more of the associated keywords. Since the advertiser typically pays for each advertisement that is provided to a user, this method enables an advertiser to avoid providing advertisements to users whose queries do not use keywords that are associated with the advertiser's products and services. However, this approach offers no mechanism for expanding an advertiser's customer base.

### SUMMARY OF THE INVENTION

In one aspect of the invention a method is provided for identifying candidate topics for the allocation of advertising resources, the method including calculating a relevance value of a candidate topic with respect to a base topic as a function of a) a number of individuals that is associated with the base topic, b) a number of individuals that is associated with the candidate topic, and c) a number of individuals that is associated with both the base topic and the candidate topic, determining that the relevance value of the candidate topic is above a predefined threshold, and identifying the candidate topic as a target for an advertising resource.

In another aspect of the invention the method further includes allocating an advertising resource to the candidate topic.

In another aspect of the invention the calculating is performed where the relevance value is proportional to a ratio between the number of individuals in the group associated with the candidate topic and the number of individuals in the group that is associated with both the base topic and the candidate topic.

In another aspect of the invention the calculating is performed where the relevance value is proportional to an advertisement targeting factor for weighting the relevance value towards or away from the size of the number of individuals in the group that is associated with both the base topic and the candidate topic versus the number of individuals in the group that is associated with the candidate topic.

In another aspect of the invention the calculating is performed where the base topic directly relates to any of goods and services offered by an advertiser, and where the candidate topic does not directly relate to the same goods and services offered by the advertiser.

In another aspect of the invention the calculating is performed where an individual is associated with any given one of the topics if the individual previously performed a search engine query using a keyword that is associated with the given topic.

In another aspect of the invention the calculating is performed where the individuals share a selected attribute.

In another aspect of the invention the allocating includes allocating an advertising budget to the candidate topic.

In another aspect of the invention the allocating includes providing an advertisement related to the base topic to an advertising recipient who is associated with the candidate topic.

In another aspect of the invention the method further includes identifying the advertising recipient as being associated with the candidate topic if the advertising recipient performs a search engine query that includes a keyword that is associated with the candidate topic.

In another aspect of the invention the calculating includes calculating also as a function of d) a number of individuals matching a predefined attribute criterion.

In another aspect of the invention the calculating includes calculating where the predefined attribute criterion defines a specific value or value range for the attribute.

In another aspect of the invention the relevance value is a first relevance value, the candidate topic is a first candidate topic, and the method further includes calculating a second relevance value of a second candidate topic with respect to the base topic, and calculating a ratio of the first relevance value with respect to the second relevance value.

In another aspect of the invention the method further includes determining that the second relevance value is above a second predefined threshold, and identifying the second candidate topic as a target for an advertising resource.

In another aspect of the invention the method further includes allocating advertising resources to the first and second candidate topics as a function of the first relevance value with respect to the second relevance value.

In another aspect of the invention the method further includes configuring any of a) computer hardware and b) computer software embodied in a non-transitory, computer-readable medium, to perform the calculating, determining, and identifying.

In another aspect of the invention a system is provided for identifying candidate topics for the allocation of advertising resources, the system including a relevance calculator that is configured to calculate a relevance value of a candidate topic with respect to a base topic as a function of a) the number of individuals in a group that is associated with the base topic, b) the number of individuals in a group that is associated with the candidate topic, and c) the number of individuals in a group that is associated with both the base topic and the candidate topic, and a candidate topic identifier configured to identify the candidate topic as a target for an advertising resource by determining that the relevance value of the candidate topic is above a predefined threshold.

In another aspect of the invention the system further includes a topic group evaluator configured to determine the number of individuals in the group that is associated with the base topic, the number of individuals in the group that is associated with the candidate topic, and the number of individuals in the group that is associated with both the base topic and the candidate topic.

In another aspect of the invention the system further includes a resource allocator that is configured to allocate an advertising resource to the candidate topic.

In another aspect of the invention the relevance calculator is further configured to calculate the relevance value as a function of a ratio between the number of individuals in the group associated with the candidate topic and the number of individuals in the group that is associated with both the base topic and the candidate topic.

In another aspect of the invention the base topic directly relates to any of goods and services offered by an advertiser, and the candidate topic does not directly relate to of the same goods and services offered by the advertiser.

In another aspect of the invention the relevance calculator is further configured to calculate where an individual is associated with any given one of the topics if the individual previously performed a search engine query using a keyword that is associated with the given topic.

In another aspect of the invention the relevance calculator is further configured to calculate where the individuals share a selected attribute.

In another aspect of the invention the resource allocator is further configured to allocate an advertising budget to the candidate topic.

In another aspect of the invention the resource allocator is further configured to allocate where the allocating includes providing an advertisement related to the base topic to an advertising recipient who is associated with the candidate topic.

In another aspect of the invention the resource allocator is further configured to identify the advertising recipient as being associated with the candidate topic if the advertising recipient performs a search engine query that includes a keyword that is associated with the candidate topic.

In another aspect of the invention the relevance calculator is configured to calculate the relevance value also as a function of d) a number of individuals matching a predefined attribute criterion.

In another aspect of the invention the predefined attribute criterion defines a specific value or value range for the attribute.

In another aspect of the invention the relevance value is a first relevance value, the candidate topic is a first candidate topic, and the relevance calculator is further configured to calculate a second relevance value of a second candidate topic with respect to the base topic, and calculate a ratio of the first relevance value with respect to the second relevance value.

In another aspect of the invention the relevance calculator is further configured to determine that the second relevance value is above a second predefined threshold, and identify the second candidate topic as a target for an advertising resource.

In another aspect of the invention further includes a resource allocator configured to allocate advertising resources to the first and second candidate topics as a function of the first relevance value with respect to the second relevance value.

In another aspect of the invention a computer program product is provided for identifying candidate topics for the allocation of advertising resources, the computer program product including a non-transitory, computer-readable storage medium, and computer-readable program code embodied in the computer-readable storage medium, where the computer-readable program code is configured to calculate a relevance value of a candidate topic with respect to a base topic as a function of a) the number of individuals in a group that is associated with the base topic, b) the number of individuals in a group that is associated with the candidate topic, and c) the number of individuals in a group that is associated with both the base topic and the candidate topic, and identify the candidate topic as a target for an advertising resource by determining that the relevance value of the candidate topic is above a predefined threshold.

In another aspect of the invention the computer-readable program code is configured to determine the number of individuals in the group that is associated with the base topic, the number of individuals in the group that is associated with the candidate topic, and the number of individuals in the group that is associated with both the base topic and the candidate topic.

In another aspect of the invention the computer-readable program code is configured to allocate an advertising resource to the candidate topic.

In another aspect of the invention the computer-readable program code is configured to calculate the relevance value as a function of a ratio between the number of individuals in the group associated with the candidate topic and the number of individuals in the group that is associated with both the base topic and the candidate topic.

In another aspect of the invention the base topic directly relates to any of goods and services offered by an advertiser, and where the candidate topic does not directly relate to of the same goods and services offered by the advertiser.

In another aspect of the invention the computer-readable program code is configured to calculate where an individual is associated with any given one of the topics if the individual previously performed a search engine query using a keyword that is associated with the given topic.

In another aspect of the invention the computer-readable program code is configured to calculate where the individuals share a selected attribute.

In another aspect of the invention the computer-readable program code is configured to allocate an advertising budget to the candidate topic.

In another aspect of the invention the computer-readable program code is configured to allocate by providing an advertisement related to the base topic to an advertising recipient who is associated with the candidate topic.

In another aspect of the invention the computer-readable program code is configured to identify the advertising recipient as being associated with the candidate topic if the advertising recipient performs a search engine query that includes a keyword that is associated with the candidate topic.

In another aspect of the invention the computer-readable program code is configured to calculate the relevance value also as a function of d) a number of individuals matching a predefined attribute criterion.

In another aspect of the invention the predefined attribute criterion defines a specific value or value range for the attribute.

In another aspect of the invention the relevance value is a first relevance value, the candidate topic is a first candidate topic, and the computer-readable program code is configured to calculate a second relevance value of a second candidate topic with respect to the base topic, and calculate a ratio of the first relevance value with respect to the second relevance value.

In another aspect of the invention the computer-readable program code is configured to determine that the second relevance value is above a second predefined threshold, and identify the second candidate topic as a target for an advertising resource

In another aspect of the invention the computer-readable program code is configured to allocate advertising resources to the first and second candidate topics as a function of the first relevance value with respect to the second relevance value.

### BRIEF DESCRIPTION OF THE DRAWINGS

The invention will be understood and appreciated more fully from the following detailed description taken in conjunction with the appended drawings in which:

FIG. 1A is a simplified conceptual illustration of a system for identifying a non-obvious target audience for an advertising campaign, constructed and operative in accordance with an embodiment of the invention;

FIG. 1B is a simplified conceptual illustration of overlapping user-topic association groups, useful in understanding the invention;

FIG. 2 is a simplified flowchart illustration of an exemplary method of operation of the system of FIG. 1A, operative in accordance with an embodiment of the invention;

FIG. 3A is a simplified flowchart illustration of another exemplary method of operation of the system of FIG. 1A, operative in accordance with an embodiment of the invention; and

FIG. 3B is a simplified conceptual illustration of overlapping user-topic association groups with attribute groupings, useful in understanding the invention.

### DETAILED DESCRIPTION OF THE INVENTION

The invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

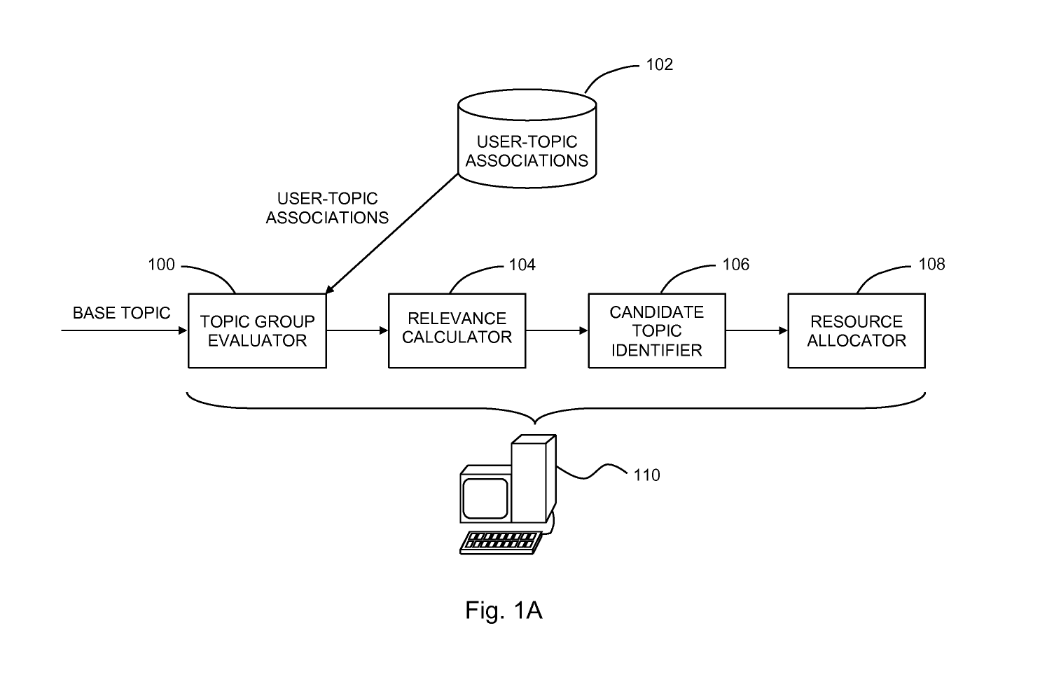

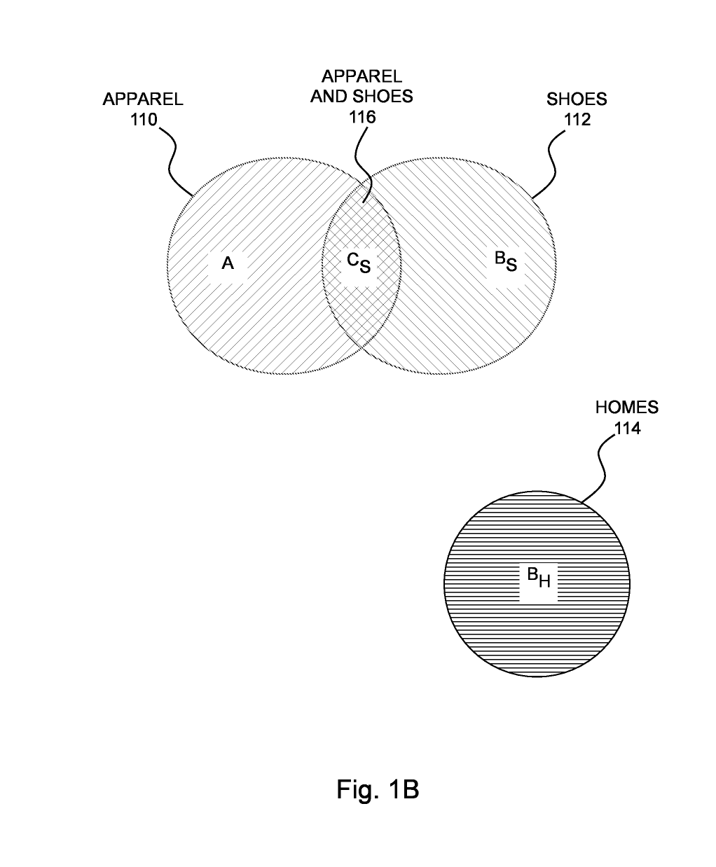

Reference is now made to FIG. 1A, which is a simplified conceptual illustration of a system for identifying a non-obvious target audience for an advertisement campaign, constructed and operative in accordance with an embodiment of the invention. In the system of FIG. 1A, a topic group evaluator 100 obtains from a user-topic associations database 102 associations between individuals, such as computer users, and one or more topics, preferably where each individual is identified by a user ID that is stored together with each association. Topic group evaluator 100 may also obtain additional attributes associated with these individuals, such as location, age, sex, social network information, income or educational information, where such attribute information is also stored in user-topic associations database 102 or is otherwise obtainable from another source (not shown).

The user-topic associations in database 102 may, for example, be derived using any known technique, such as by obtaining keywords of search engine queries performed by computer users, comparing the keywords with predefined associations between the keywords and various topics, and then mapping the computer users to the keyword-associated topics. Additionally or alternatively, the user-topic associations in database 102 may, for example, be derived by tracking the web page browsing habits of computer users, obtaining conversion data from retailers, or from historical data.

The topics themselves may, for example, be defined as broad categories of interest to advertisers, such as apparel, sporting goods, or automobiles, or more narrowly, such as hats, golf clubs, and shampoos.

Topic group evaluator 100 is configured to obtain a base topic, such as by receiving a base topic definition from an advertiser, where the base topic is typically associated with goods and/or services offered by the advertiser. Topics other than the base topic and which are not typically associated by the advertiser with an advertising target of the advertiser, are now referred to as candidate topics. Typically, the base topic directly relates to goods and/or services offered by the advertiser, whereas a candidate topic does not directly relate to the same goods and/or services offered by the advertiser. Candidates topics are candidates for the allocation of advertising resources as will now be described.

Topic group evaluator 100 is preferably configured to group the obtained user-topic associations by topic, including the base topic, and determine the number of individuals in the base topic group and in each of the candidate topic groups. Topic group evaluator 100 also preferably identifies overlaps between any of the topic groups, and particularly between the base topic group and any candidate topic group, and determines the number of individuals that belong to any identified overlaps, where an overlap is present between two topics if an individual is associated with both topics. For example, FIG. 1B shows a base topic of ‘apparel’ 110, as well as candidate topics ‘shoes’ 112, and ‘homes’ 114. Topic group evaluator 100 determines that there are 150 individuals associated with ‘apparel’ and who are not known to be associated with ‘shoes’, denoted in FIG. 1B as A. Topic group evaluator 100 also determines that there are 100 individuals associated with ‘shoes’ and who are not known to be associated with ‘apparel’, denoted in FIG. 1B as B_{S}. Topic group evaluator 100 also determines that there are 40 individuals associated with both ‘apparel’ and ‘shoes’, as illustrated by overlap 116 between groups ‘apparel’ 110 and ‘shoes’ 112, denoted in FIG. 1B as C_{S}. Topic group evaluator 100 also determines that there are 80 individuals associated with ‘homes’, denoted in FIG. 1B as B_{H}, and that the number of these individuals who are also associated with ‘apparel’ and/or ‘homes’ is zero.

A relevance calculator 104 is preferably configured to calculate a relevance value for any candidate topic with respect to the base topic as a function of the number of individuals that are associated with the base topic, the number of individuals that are associated with the candidate topic, and the number of individuals that are associated with both the base topic and the candidate topic. For example, where A=the number of individuals that are associated with a base topic but not known to be associated with a candidate topic, B=the number of individuals that are associated with a candidate topic but not known to be associated with the base topic, and C=the number of individuals that are associated with both the base topic and the candidate topic, the relevance value of the candidate topic with respect to the base topic may be calculated as follows:

$$\begin{matrix}Relevance Value = \frac{E * H}{E + H} \\ where & ( EQ . 1 ) \\ H = C / ( B + C ) \\ and & ( EQ . 2 ) \\ E = B / ( A + C ) & ( EQ . 3 )\end{matrix}$$

In this configuration E represents the “exposing” potential which quantifies the ratio between the candidate topic group and the base topic group and expresses the potential to expose, or expand to, a customer base beyond those customers who are directly associated with the base topic to customers that aren't directly associated with the base topic, while H represents the “hidden” potential which quantifies the ratio between the overlap group and the candidate topic group and expresses, among the users associated with the candidate topic, the size of the potential customer that are completely unknown, or hidden, from the advertiser as compared to those users of which the advertiser is already aware. For example, referring again to the example of FIG. 1B, the relevance value of ‘shoes’ with respect to ‘apparel’ is calculated as follows:

H_{S}=C_{S}/(B_{S}+C_{S})=40/(100+40) or 0.29

E_{S}=B_{S}/(A+C_{S})=100/(150+40) or 0.53

Relevance value=(E_{S}*H_{S})/(E_{S}+H_{S})=0.19, allowing for two significant digits.

The relevance value of ‘homes’ with respect to ‘apparel’ is calculated as:

H_{H}=C_{H}/(B_{H}+C_{H})=0/(100+0) or 0.0

E_{H}=B_{H}/(A+C_{H})=100/(150+0) or 0.67

Relevance value=(E_{S}*H_{S})/(E_{S}+H_{S})=0.0.

Thus, both the actual size and relative size of the overlap group between the base topic and candidate topic groups affect the relevance value.

Relevance calculator 104 may also be configured to employ an advertisement targeting factor β for weighting the relevance value towards or away from the size of the overlap versus the size of the candidate topic group. The relevance value of the candidate topic with respect to the base topic may be calculated as follows:

$$Relevance Value = \frac{( 1 + {β}^{2} ) * E * H}{{β}^{2} * ( E + H )} \qquad ( EQ . 4 )$$

For example, using the numerical example above, for a β value of 2, the relevance value of ‘shoes’ with respect to ‘apparel’ is 0.23, whereas for a β value of 0.5, the relevance value of ‘shoes’ with respect to ‘apparel’ is 0.93. Thus a value of β>1 puts more emphasis on H than E, and a value of β<1 puts more emphasis on E than H. In the example above, a value of β=2 slightly increased the relevance value of ‘shoes’ with respect to ‘apparel’ since H_{S} is relatively small. However, a value of β=0.5 significantly increased the relevance value of ‘shoes’ with respect to ‘apparel’ since is E_{S} relatively large.

A candidate topic identifier 106 is preferably configured to determine if the relevance value of any candidate topic is above a predefined threshold, and identify any candidate topic whose relevance value is above the predefined threshold as a target for the allocation of advertising resources. Using the above numerical example, the relevance values for ‘shoes’ with respect to ‘apparel’ are all greater than zero, and thus ‘shoes’ is a target candidate topic for advertising resources that are associated with ‘apparel’, and therefore advertising resources relating to ‘apparel’ may be allocated to individuals that are associated with ‘shoes’. For example, an advertising budget for apparel advertisements may be allocated to target computer users who perform search engine queries that include a keyword that is associated with shoes. Conversely, the relevance value of ‘homes’ with respect to ‘apparel’ is zero, and thus ‘homes’ is not a target candidate topic for the allocation of advertising resources that are associated with ‘apparel’.

A resource allocator 108 is preferably configured to allocate advertising resources to target candidate topics, such as by allocating to a target candidate topic an advertising budget related to a base topic and providing an advertisement related to a base topic to an individual who is associated with the candidate topic of relevance to the base topic. Resource allocator 108 is preferably configured to allocate advertising resources to target candidate topics in proportion to their respective relevance values. For example, consider an advertiser whose base topic is ‘apparel’, where 80% of the advertiser's advertising budget for advertising related to apparel is to be allocated to users whose search engine queries include keywords associated with apparel, while the remaining 20% is to be allocated to target candidate topics. If the relevance value for the candidate topic ‘shoes’ is 0.6 with respect to the base topic ‘apparel’, and the relevance value for the candidate topic ‘sports’ is 0.4 with respect to the same base topic ‘apparel’, and both relevance values exceed their thresholds, then resource allocator 108 allocates 0.6×20% of the advertising budget to users whose search engine queries include keywords associated with ‘shoes’ and 0.4×20% of the advertising budget to users whose search engine queries include keywords associated with ‘sports’.

Any of the elements shown in FIG. 1A are preferably implemented by one or more computers, such as by a computer 110, in computer hardware and/or in computer software embodied in a non-transitory, computer-readable medium in accordance with conventional techniques.

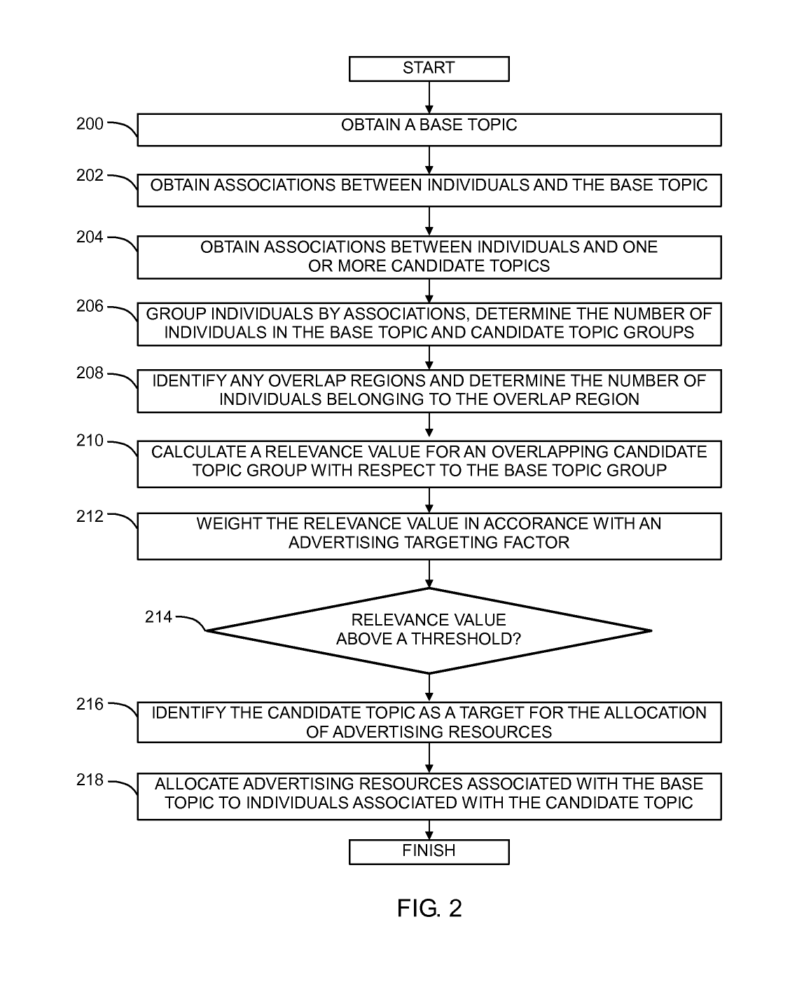

Reference is now made to FIG. 2, which is a simplified flowchart illustration of an exemplary method of operation of the system of FIG. 1A, operative in accordance with an embodiment of the invention. In the method of FIG. 2 a base topic is obtained (step 200), such as from an advertiser. Associations between individuals, such as computer users, and the base topic are obtained (step 202), as are associations between individuals and one or more candidate topics (step 204). The obtained associations are grouped by topic, including the base topic, to determine the number of individuals in the base topic group and in each of the candidate topic groups (step 206). Overlaps between any of the topic groups, and particularly between the base topic group and any candidate topic group, are identified (step 208) by determining the number of individuals that belong to any identified overlaps, where an overlap is present between two topics if an individual is associated with both topics. A relevance value is calculated for any candidate topic with respect to the base topic as a function of the number of individuals that are associated with the base topic, the number of individuals that are associated with the candidate topic, and the number of individuals that are associated with both the base topic and the candidate topic (step 210). Any relevance value is optionally weighted towards or away from the size of the overlap versus the size of the candidate topic group using an advertisement targeting factor (step 212). If the relevance value of any candidate topic is above a predefined threshold (step 214), then such a candidate topic is identified as a target for the allocation of advertising resources (step 216), and advertising resources associated with the base topic are allocated to individuals that are associated with the target candidate topic (step 218).

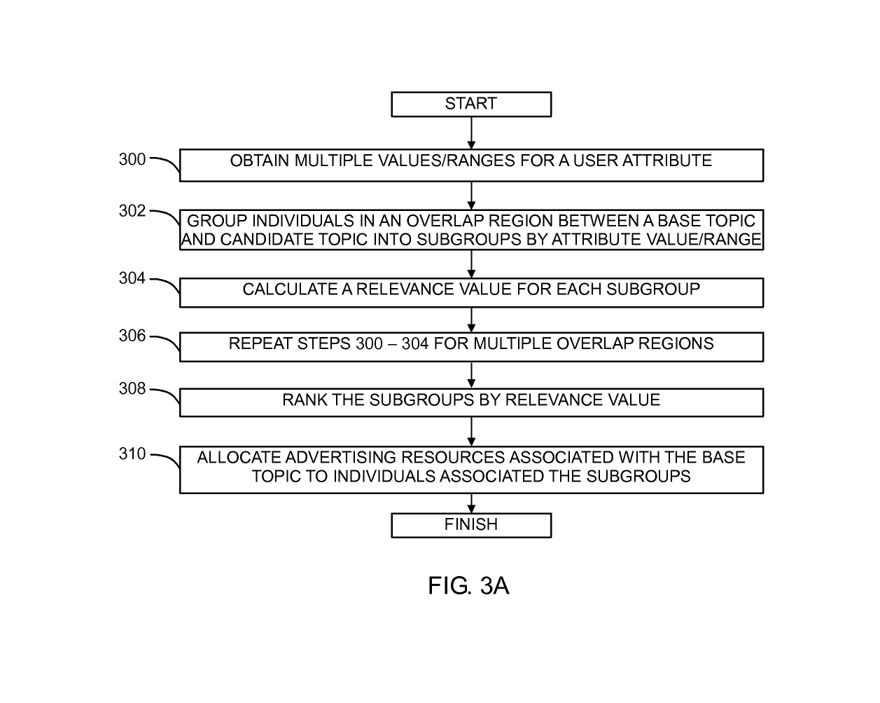

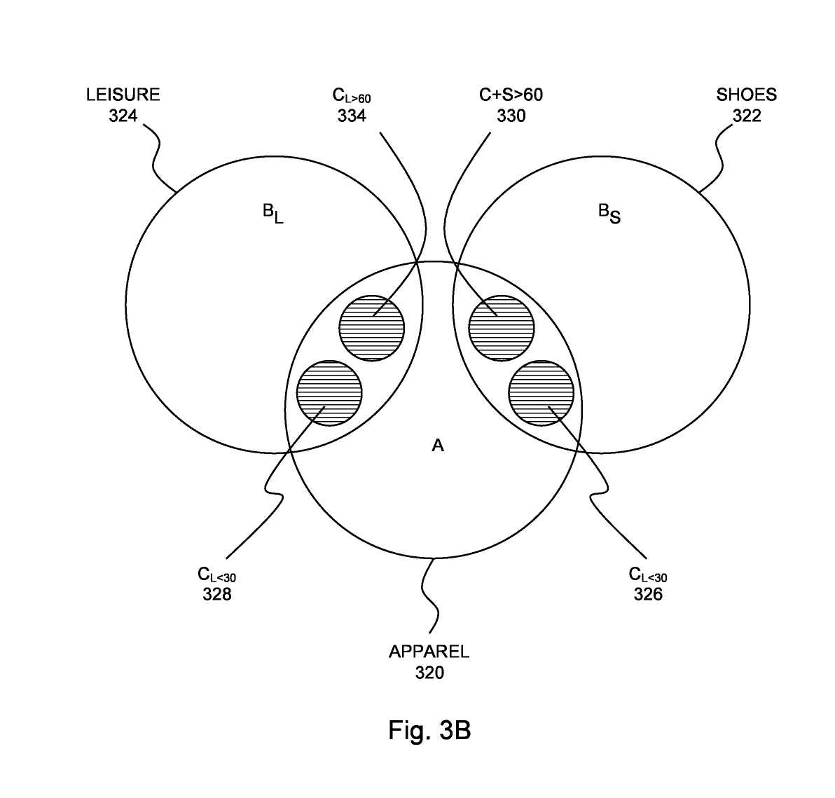

Reference is now made to FIG. 3A, which is a simplified flowchart illustration of another exemplary method of operation of the system of FIG. 1A, operative in accordance with an embodiment of the invention. In the method of FIG. 3A multiple target values or target value ranges are obtained for a user attribute (Step 300), such as from an advertiser. An overlap group, such as is determined using the method of FIG. 2 and whose relevance value exceeds a predefined threshold, is organized into multiple subgroups corresponding to the target attribute values or value ranges (Step 302), by grouping individuals in the overlap group into a subgroup where an individual possesses the attribute, and where the individual's attribute matches a predefined attribute criterion, such as where the attribute value for an individual matches a corresponding target attribute value or value range. Relevance values are calculated for each of the subgroups (Step 304), such as by using a method similar to that which is described hereinabove for an overlap group, where the subgroup relevance value is calculated as a function of the ratio of the number of individuals included in the subgroup to the number of individuals included in the overlap group, as well as the relevance value of the overlap group. Steps 300-304 may be repeated for additional overlap groups, such as for overlap between multiple candidate topics and a base topic (Step 306). The subgroups are preferably ranked by their subgroup relevance values (Step 308). Advertising resources are preferably allocated to the subgroups in accordance with their respective rank (Step 310), such as by dividing an advertising budget among the subgroups in proportion to the rank of the subgroups.

The method of FIG. 3A may be illustrated by way of example as shown in FIG. 3B which shows a base topic 320 of ‘apparel’, denoted as A, a candidate topic 322 of ‘shoes’, denoted B_{S}, and a candidate topic 324 of ‘leisure’, denoted B_{L}. Two overlap groups are determined to have relevance values above their associated thresholds: an overlap group 326, denoted as C_{S}, associated with both ‘apparel’ and ‘shoes’ and including 40 individuals, and an overlap group 328 denoted as C_{L}, associated with both ‘apparel’ and ‘leisure’ and including 50 individuals. Overlap groups C_{S} 326 and C_{L} 328 are further divided into 4 subgroups 330, 332, 334, and 336 by a user attribute, being age, and attribute values of age <30 and age >60, as follows:
subgroup 330, denoted as C_{S>60}, including 25 individuals who are associated with both ‘apparel’ and ‘shoes’ and are over the age of 60;
subgroup 332, denoted as C_{S<30}, including 15 individuals who are associated with both ‘apparel’ and ‘shoes’ and are under the age of 30;
subgroup 334, denoted as C_{L>60}, including 20 individuals who are associated with both ‘apparel’ and ‘leisure’ and are over the age of 60;
subgroup 336, denoted as C_{L<30}, including 30 individuals who are associated with both ‘apparel’ and ‘leisure’ and are under the age of 30;

A relevance score is calculated for each subgroup as a function of the number of individuals included in each subgroup relative to the number of individuals included in the associated overlap group, and additionally of the relevance value of the associated overlap group. For relevance values of 0.3 and 0.4 for overlap groups C_{S} 326 and C_{L} 328, respectively, the relevance value for
C_{S>60} is calculated as 25/40, or 0.625, multiplied by the overlap relevance value 0.3, giving 0.19;
C_{S<30} is calculated as 15/40, or 0.375, multiplied by the overlap relevance value 0.3, giving 0.11;
C_{L>60} is calculated as 20/50, or 0.4, multiplied by the overlap relevance value 0.4, giving 0.16; and
C_{L<30} is calculated as 30/50, or 0.6, multiplied by the overlap relevance value 0.4, giving 0.24.

An advertising budget may then be allocated proportionately according to the following ranking, from highest to lowest:
1. C_{L<30}−[0.24/(0.19+0.11+0.16+0.24)]*100=34% of the budget (rounded)
2. C_{S>60}−[0.19/(0.19+0.11+0.16+0.24)]*100=27% of the budget (rounded)
3. C_{L>60}−[0.16/(0.19+0.11+0.16+0.24)]*100=23% of the budget (rounded)
4. C_{S<30}−[0.11/(0.19+0.11+0.16+0.24)]*100=16% of the budget (rounded)

It is appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The flowchart and block diagrams in the drawing figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer.

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for identifying candidate topics for the allocation of advertising resources, the method comprising:
calculating a relevance value of a candidate topic with respect to a base topic as a function of
a) a number of individuals that is associated with the base topic,
b) a number of individuals that is associated with the candidate topic, and
c) a number of individuals that is associated with both the base topic and the candidate topic;
determining that the relevance value of the candidate topic is above a predefined threshold; and
identifying the candidate topic as a target for an advertising resource.

2. The method according to claim 1 and further comprising allocating an advertising resource to the candidate topic.

3. The method according to claim 1 wherein the calculating is performed wherein the relevance value is proportional to a ratio between the number of individuals in the group associated with the candidate topic and the number of individuals in the group that is associated with both the base topic and the candidate topic.

4. The method according to claim 1 wherein the calculating is performed wherein the relevance value is proportional to an advertisement targeting factor for weighting the relevance value towards or away from the size of the number of individuals in the group that is associated with both the base topic and the candidate topic versus the number of individuals in the group that is associated with the candidate topic.

5. The method according to claim 1 wherein the calculating is performed wherein the base topic directly relates to any of goods and services offered by an advertiser, and wherein the candidate topic does not directly relate to the same goods and services offered by the advertiser.

6. The method according to claim 1 wherein the calculating is performed wherein an individual is associated with any given one of the topics if the individual previously performed a search engine query using a keyword that is associated with the given topic.

7. The method according to claim 1 wherein the calculating is performed wherein the individuals share a selected attribute.

8. The method according to claim 2 wherein the allocating comprises allocating an advertising budget to the candidate topic.

9. The method according to claim 2 wherein the allocating comprises providing an advertisement related to the base topic to an advertising recipient who is associated with the candidate topic.

10. The method according to claim 9 and further comprising identifying the advertising recipient as being associated with the candidate topic if the advertising recipient performs a search engine query that includes a keyword that is associated with the candidate topic.

11. The method according to claim 1 wherein the calculating comprises calculating also as a function of d) a number of individuals matching a predefined attribute criterion.

12. The method according to claim 11 wherein the calculating comprises calculating wherein the predefined attribute criterion defines a specific value or value range for the attribute.

13. The method according to claim 1 wherein the relevance value is a first relevance value, wherein the candidate topic is a first candidate topic, and further comprising:
calculating a second relevance value of a second candidate topic with respect to the base topic; and
calculating a ratio of the first relevance value with respect to the second relevance value.

14. The method according to claim 13 and further comprising:
determining that the second relevance value is above a second predefined threshold; and
identifying the second candidate topic as a target for an advertising resource.

15. The method according to claim 13 and further comprising allocating advertising resources to the first and second candidate topics as a function of the first relevance value with respect to the second relevance value.

16. The method of claim 1 and further comprising configuring any of
a) computer hardware and
b) computer software embodied in a non-transitory, computer-readable medium, to perform the calculating, determining, and identifying.

17. A system for identifying candidate topics for the allocation of advertising resources, the system comprising:
a relevance calculator that is configured to calculate a relevance value of a candidate topic with respect to a base topic as a function of
a) the number of individuals in a group that is associated with the base topic,
b) the number of individuals in a group that is associated with the candidate topic, and
c) the number of individuals in a group that is associated with both the base topic and the candidate topic; and
a candidate topic identifier configured to identify the candidate topic as a target for an advertising resource by determining that the relevance value of the candidate topic is above a predefined threshold.

18. The system according to claim 17 and further comprising a topic group evaluator configured to determine the number of individuals in the group that is associated with the base topic, the number of individuals in the group that is associated with the candidate topic, and the number of individuals in the group that is associated with both the base topic and the candidate topic.

19. The system according to claim 17 and further comprising a resource allocator that is configured to allocate an advertising resource to the candidate topic.

20. The system according to claim 17 wherein the relevance calculator is further configured to calculate the relevance value as a function of a ratio between the number of individuals in the group associated with the candidate topic and the number of individuals in the group that is associated with both the base topic and the candidate topic.

21. The system according to claim 17 wherein the calculating is performed wherein the base topic directly relates to any of goods and services offered by an advertiser, and wherein the candidate topic does not directly relate to of the same goods and services offered by the advertiser.

22. The system according to claim 17 wherein the relevance calculator is further configured to calculate wherein an individual is associated with any given one of the topics if the individual previously performed a search engine query using a keyword that is associated with the given topic.

23. The system according to claim 17 wherein the relevance calculator is further configured to calculate wherein the individuals share a selected attribute.

24. The system according to claim 19 wherein the resource allocator is further configured to allocate an advertising budget to the candidate topic.

25. The system according to claim 19 wherein the resource allocator is further configured to allocate wherein the allocating comprises providing an advertisement related to the base topic to an advertising recipient who is associated with the candidate topic.

26. The system according to claim 25 wherein the resource allocator is further configured to identify the advertising recipient as being associated with the candidate topic if the advertising recipient performs a search engine query that includes a keyword that is associated with the candidate topic.

27. The system according to claim 17 wherein the relevance calculator is configured to calculate the relevance value also as a function of d) a number of individuals matching a predefined attribute criterion.

28. The system according to claim 17 wherein the predefined attribute criterion defines a specific value or value range for the attribute.

29. The system according to claim 17 wherein the relevance value is a first relevance value, wherein the candidate topic is a first candidate topic, and wherein the relevance calculator is further configured to:
calculate a second relevance value of a second candidate topic with respect to the base topic; and
calculate a ratio of the first relevance value with respect to the second relevance value.

30. The system according to claim 29 wherein the relevance calculator is further configured to:
determine that the second relevance value is above a second predefined threshold; and
identify the second candidate topic as a target for an advertising resource.

31. The system according to claim 29 and further comprising a resource allocator configured to allocate advertising resources to the first and second candidate topics as a function of the first relevance value with respect to the second relevance value.

32. A computer program product for identifying candidate topics for the allocation of advertising resources, the computer program product comprising:
a non-transitory, computer-readable storage medium, and
computer-readable program code embodied in the computer-readable storage medium, wherein the computer-readable program code is configured to
calculate a relevance value of a candidate topic with respect to a base topic as a function of
a) the number of individuals in a group that is associated with the base topic,
b) the number of individuals in a group that is associated with the candidate topic, and
c) the number of individuals in a group that is associated with both the base topic and the candidate topic, and
identify the candidate topic as a target for an advertising resource by determining that the relevance value of the candidate topic is above a predefined threshold.

33. The computer program product according to claim 32 wherein the computer-readable program code is configured to determine the number of individuals in the group that is associated with the base topic, the number of individuals in the group that is associated with the candidate topic, and the number of individuals in the group that is associated with both the base topic and the candidate topic.

34. The computer program product according to claim 32 wherein the computer-readable program code is configured to allocate an advertising resource to the candidate topic.

35. The computer program product according to claim 32 wherein the computer-readable program code is configured to calculate the relevance value as a function of a ratio between the number of individuals in the group associated with the candidate topic and the number of individuals in the group that is associated with both the base topic and the candidate topic.

36. The computer program product according to claim 32 wherein the base topic directly relates to any of goods and services offered by an advertiser, and wherein the candidate topic does not directly relate to of the same goods and services offered by the advertiser.

37. The computer program product according to claim 32 wherein the computer-readable program code is configured to calculate wherein an individual is associated with any given one of the topics if the individual previously performed a search engine query using a keyword that is associated with the given topic.

38. The computer program product according to claim 32 wherein the computer-readable program code is configured to calculate wherein the individuals share a selected attribute.

39. The computer program product according to claim 34 wherein the computer-readable program code is configured to allocate an advertising budget to the candidate topic.

40. The computer program product according to claim 34 wherein the computer-readable program code is configured to allocate by providing an advertisement related to the base topic to an advertising recipient who is associated with the candidate topic.

41. The computer program product according to claim 40 wherein the computer-readable program code is configured to identify the advertising recipient as being associated with the candidate topic if the advertising recipient performs a search engine query that includes a keyword that is associated with the candidate topic.

42. The computer program product according to claim 32 wherein the computer-readable program code is configured to calculate the relevance value also as a function of d) a number of individuals matching a predefined attribute criterion.

43. The computer program product according to claim 32 wherein the predefined attribute criterion defines a specific value or value range for the attribute.

44. The computer program product according to claim 32 wherein the relevance value is a first relevance value, wherein the candidate topic is a first candidate topic, and wherein the computer-readable program code is configured to:
calculate a second relevance value of a second candidate topic with respect to the base topic, and
calculate a ratio of the first relevance value with respect to the second relevance value.

45. The computer program product according to claim 44 wherein the computer-readable program code is configured to:
determine that the second relevance value is above a second predefined threshold, and
identify the second candidate topic as a target for an advertising resource.

46. The computer program product according to claim 44 wherein the computer-readable program code is configured to allocate advertising resources to the first and second candidate topics as a function of the first relevance value with respect to the second relevance value.
